(19) United States
(12) Patent Application Publication
(10) Pub. No.: US 2007/0096423 A1
(43) Pub. Date: May 3, 2007

(54) Hand-driven cycle

(76) Inventor: Georgi Georgiev, Gabriola Island, British Columbia (CA)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 11/549,184

(22) Filed: Oct. 13, 2006

(30) Foreign Application Priority Data
Oct. 13, 2005 (NL) 1030184

(51) Int. Cl. B62M 1/14

(52) U.S. Cl. 280/242.1

(57) ABSTRACT

The present invention relates to a hand-driven cycle on the front wheel, having a frame, a rear wheel assembly arranged on a first side of the frame, and a front wheel assembly which is arranged on a second side of the frame and which can be coupled pivotally to the frame by means of a fork column assembly. The front wheel assembly has a fork for holding a wheel axle, a drive member to be driven by muscle power of a rider of the cycle, and a drive shaft for transmitting the muscle power to the front wheel by means of a transmission assembly, which the drive shaft is arranged between the wheel axle and the fork column assembly.

### CROSS-REFERENCE TO RELATED APPLICATIONS

This application is an U.S. application under 35 U.S.C. §119(a) based upon co-pending Netherland Application No. NL 1030184 filed Oct. 13, 2005. Additionally, this U.S. application claims the benefit of priority of co-pending Netherland Application No. NL 1030184 filed Oct. 13, 2005. The entire disclosures of the prior application is incorporated herein by reference.

### BACKGROUND OF THE INVENTION

1. Field of the Invention

The present invention relates to a hand-driven cycle. Hand-driven cycles are per se already known. Such cycles do however have a number of drawbacks which are obviated by means of improvements proposed in this text.

2. Description of the Prior Art

Hand-driven cycles generally have a complex construction and are three-wheeled with a low, wide and cumbersome-looking construction in order to prevent overturning in bends. The image is therefore not optimal because three-wheeled cycles with a cumbersome construction are generally used by people with a disability.

In accordance with recent insights gained during competitions, it is recommended in the case of hand-driven cycles that the rider has a high sitting position relative to the crankshaft. The rider can hereby apply more body muscles for drive purposes, this also being referred to in the jargon as ATP (arm-trunk power), which implies an improvement compared to use of only arm-power (AP). The use of ATP has drawn attention to a further drawback of known hand-driven cycles that the desired relatively high sitting position reduces stability in bends.

In order to obviate the above stated drawbacks, the present invention provides a hand-driven cycle on the front wheel, comprising:
a frame,
a rear wheel assembly arranged on a first side of the frame,
a front wheel assembly which is arranged on a second side of the frame and which can be coupled pivotally to the frame by means of a fork column assembly, wherein the front wheel assembly comprises:
a fork for holding a wheel axle,
a drive member to be driven by muscle power of a rider of the cycle,
a drive shaft for transmitting the muscle power to the front wheel by means of a transmission assembly, which drive shaft is arranged between the wheel axle and the fork column assembly.

An advantage of arranging the drive shaft or crankshaft under the fork column is that it can advantageously be situated relatively low relative to the seat of the rider, wherein the seat of the rider can also be arranged relatively high in the cycle relative to the drive shaft. It is hereby possible to apply ATP.

A further advantage is that the construction can be readily embodied in elegant manner, which provides advantageous effects in the manufacture of the cycle because the number of components and the weight thereof can be reduced. The resulting cycle is also visually more attractive to a wider public.

### SUMMARY OF THE INVENTION

In view of the foregoing disadvantages inherent in the known types of manually driven cycles now present in the prior art, the present invention provides an improved hand-driven cycle, and overcomes the above-mentioned disadvantages and drawbacks of the prior art. As such, the general purpose of the present invention, which will be described subsequently in greater detail, is to provide a new and improved hand-driven cycle and method which has all the advantages of the prior art mentioned heretofore and many novel features that result in a hand-driven cycle which is not anticipated, rendered obvious, suggested, or even implied by the prior art, either alone or in any combination thereof.

A first preferred embodiment relates to such a cycle wherein the drive shaft is arranged on the front fork. This provides a simple construction option for a cycle with the drive shaft between the wheel axle and the fork column assembly.

In the cycle the frame preferably comprises a tube extending rearward from the fork column assembly. An advantage hereof is that components such as leg and foot supports can be positioned and displaced freely along this one tube for optimal modification of the cycle to a rider.

In a further preferred embodiment the drive member on either side of the drive shaft has a bent form leading to a handgrip on either side which is suitable for rotation about the drive shaft, wherein the handgrips are rotatable outside the legs of the rider. Such a drive member is also referred to in the jargon as a bullhorn because of the form, which is substantially similar to a horn of a bull. An advantage hereof is that the movement of the arms and the drive member during riding and steering can remain outside the orientation of the legs of the rider.

The frame tube preferably comprises a steering bend close to the fork column assembly for accommodating relevant components of the transmission assembly during a steering movement. Relatively large gear wheels for instance can hereby be applied on the drive shaft and steering also remains possible. The bend can be constructed in different directions. Preferred directions are described in greater detail hereinbelow.

In a further embodiment the rear wheel assembly of the cycle comprises a rear wheel which is arranged substantially in line with a virtual centre line of the frame. An advantage of applying only one rear wheel is that the hand-driven cycle acquires riding characteristics similar to those of a foot-driven cycle with two wheels. Such a construction is also made possible because of the simple construction of the front wheel assembly. A further advantage of applying one rear wheel and one front wheel is that the relatively high sitting height of the rider in relation to the crankshaft, which is already relatively low according to the present invention, is possible because leaning inward in bends takes place as in all two-wheeled vehicles.

In a further embodiment the rear wheel assembly comprises a bend which is formed such that the rear wheel, in co-action with the rear wheel assembly, is substantially aligned with the centre line. The construction of the rear part of the cycle can hereby take a simple form for the purpose of simple production and an attractive appearance. A relatively low weight is also achieved.

For the purpose of supporting the legs of the rider, the cycle comprises a first support for supporting the knees or the upper parts of the shins which is arranged forwardly of a saddle on the frame tube, and a second support rearward and downward relative to the first support for supporting the feet, ankles or lower parts of the shins.

A further preferred embodiment according to the present invention relates to a cycle as stated in the foregoing, wherein the rear wheel assembly comprises a rear axle extending to two sides substantially perpendicularly of a virtual centre line of the frame for the purpose of holding two wheels on either side of the centre line. It hereby becomes possible to provide a three-wheeled construction which can be mounted at a single mounting point.

The rear axle herein preferably comprises on either side a sharp bend or a tube placed obliquely in the axle for arranging the wheels in a tilted position. Such a wheel arrangement on the basis of this axle provides a wider wheelbase with a relatively short axle length.

The cycle preferably comprises a biasing assembly for holding the rear wheel assembly under bias in a predetermined orientation relative to the frame. It hereby becomes possible to allow the frame to tilt relative to the rear wheel assembly, and thereby relative to the road surface during use, while the wheels maintain contact with the road surface. Such an embodiment therefore provides a displacement of the centre of gravity when a bend is negotiated, in substantially similar manner as in the case of a two-wheeler. Higher speeds are hereby possible during negotiating of a bend.

An embodiment of the biasing assembly comprises a torsion member which close to one end is mounted on the rear wheel assembly and close to the other end is mounted on the frame, for the purpose of providing the bias, and a rotation member for rotating the rear wheel assembly relative to the frame, and the frame comprises a fixing location for fixing an end part of the torsion member. This torsion member provides a relatively simple construction in order to achieve that the frame remains upright without intervention.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

Further advantages, features and details of the present invention will be described hereinbelow on the basis of several preferred embodiment and with reference to the accompanying figures, in which:

FIG. 1 shows a perspective view of a first preferred embodiment according to the present invention;

FIG. 2 shows a further perspective view of the embodiment according to FIG. 1;

FIG. 3 shows a perspective view of a detail of the embodiment of FIG. 1;

FIG. 4 is a perspective view of a detail IV of the embodiment of FIG. 1;

FIG. 5 is a perspective view of a further detail of the embodiment of FIG. 3;

FIG. 6 shows a perspective view of a detail of FIG. 1;

FIG. 7 is a top view of the embodiment of FIG. 1;

FIG. 8 shows a side view of the embodiment of FIG. 1;

FIG. 9 is a rear view of the embodiment of FIG. 1;

FIG. 10 shows a perspective view of a further embodiment according to the present invention;

FIG. 11 is a top view of the embodiment of FIG. 10 with the handlebar in a first position; and

FIG. 12 is a top view of the embodiment of FIG. 10 with the handlebar in a second position.

The same reference numerals refer to the same parts throughout the various figures.

### DESCRIPTION OF THE PREFERRED EMBODIMENT

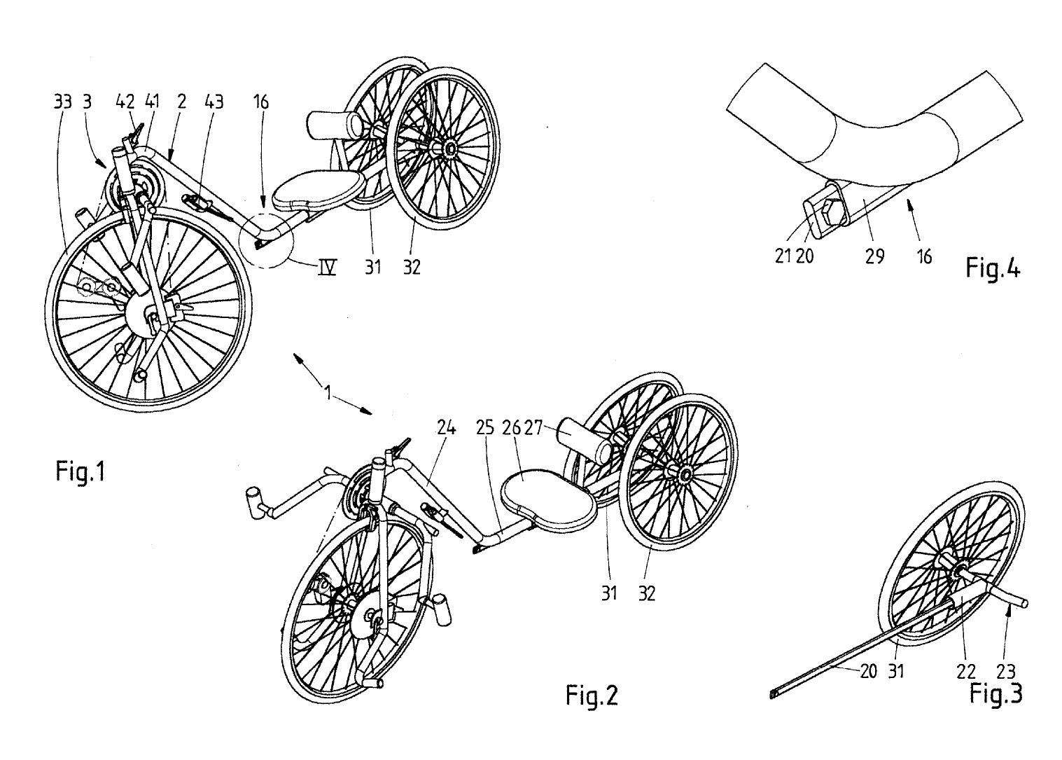

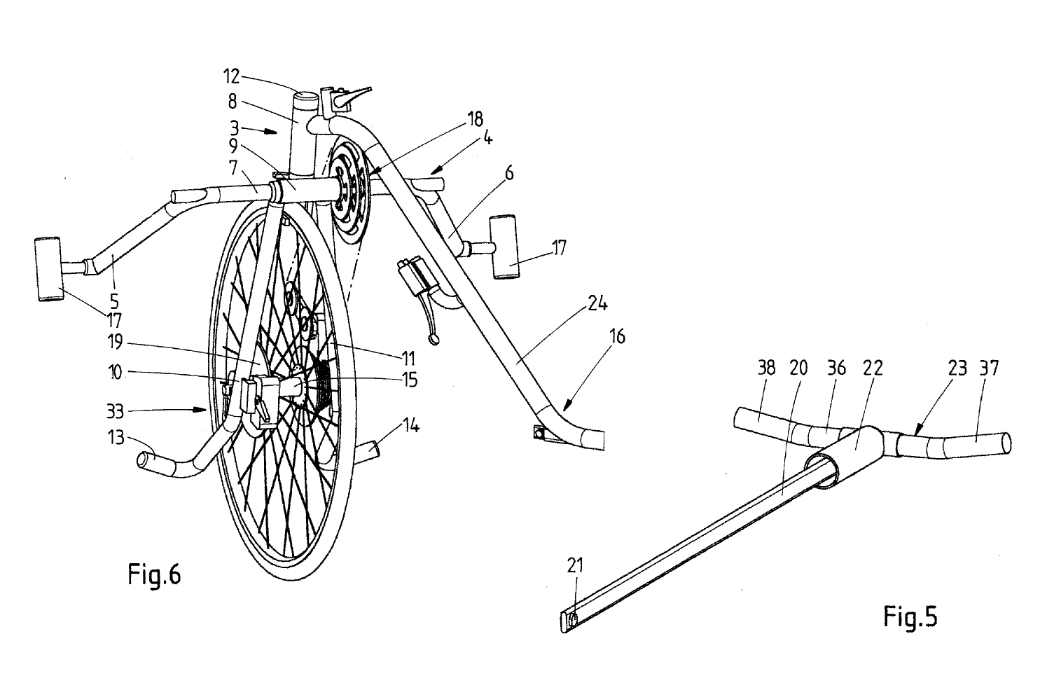

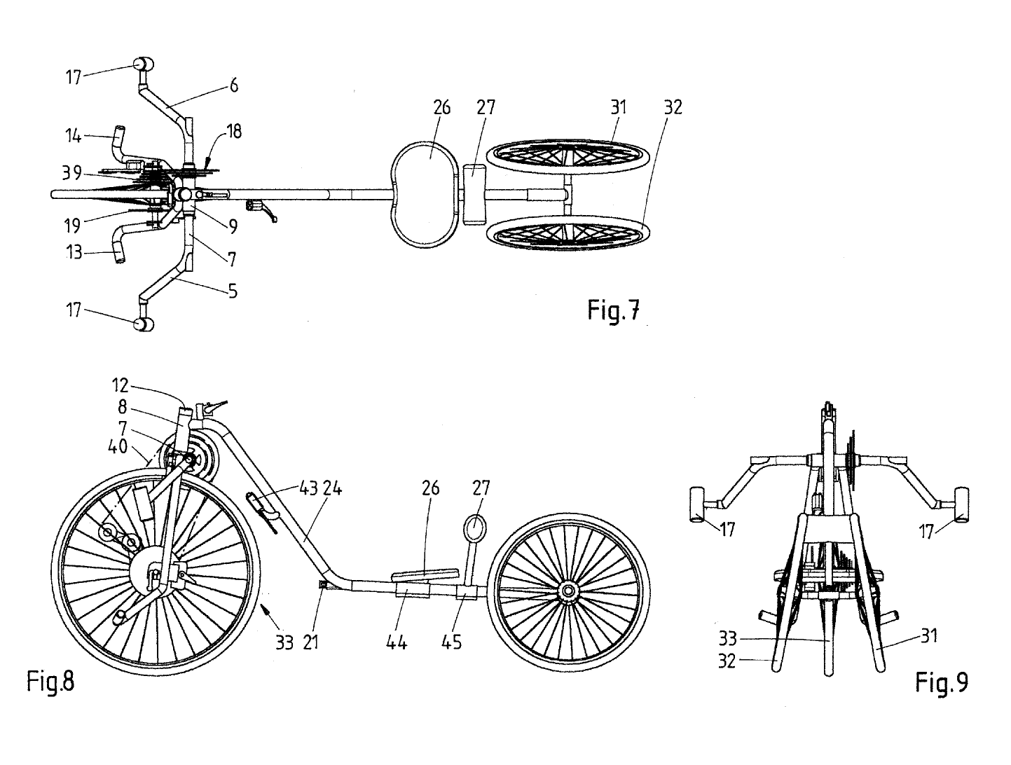

A first preferred embodiment according to the present invention relates to a hand-driven cycle 1 (FIG. 1-9). For the purpose of manual drive the cycle 1 is provided with a drive mechanism comprising a gear transmission. According to the present invention the crankshaft housing 9 is here arranged on the front fork 10,11 just above front wheel 33. The lowest possible orientation of the crankshaft is hereby achieved and the largest possible front wheel can be applied, this being advantageous in respect of the riding characteristics of the cycle, such as a low rolling resistance. It is hereby also possible for ATP to be applied.

The cycle is based on a frame tube 2 extending from fork column assembly 3 to a position close to rear axle 23. This structure provides a simple central construction and makes it possible for diverse components, such as saddle 26 and diverse supports such as backrest 27, to be placed at positions desired by the user by sliding thereof in lengthwise direction of the tube. Fixing takes place by means of supports 44,45.

Fork column 8 serves to provide the rotation of the front fork, whereby the cycle becomes steerable by means of the front wheel. Situated on the top side of the fork column is a fastening bolt 12 with which the front fork is fastened. Per se known bearings for rotation purposes are situated in fork column 8. The front fork comprises two fork tubes 10,11 which extend downward along two sides of wheel 33 to wheel axle 15. At the top the housing 9 of the crankshaft is arranged on the front fork. The central part of the crankshaft extends through this housing. The crankshaft is bearing mounted in housing 9.

Arranged on the right-hand side of crankshaft housing 9 is a gear wheel assembly 18 for transmitting the drive to gear wheel assembly 39 arranged on wheel axle 15. Further provided are two brake systems, a disc brake 19 close to the axle and a rim brake which engages on the rim of the wheel. These brakes can be operated by means of brake cables (not shown) from the brake lever 43 or from brake levers (not shown) on the handlebar at the position of handgrips 17. Further extending from front fork bars 10,11 are two respective footrests 13,14 on which the rider can support his/her feet during riding.

A bullhorn 4 integrated with the drive shaft is provided for the driving. This bullhorn extends on either side from crankshaft 7 to handgrips 17 by means of oblique rods 5. The wide bullhorn makes it possible that during rotation it encounters no obstruction from either the gear wheels or the legs of the rider. A further function of this drive mechanism is to steer the cycle.

Frame tube 2 comprises a steering bend 41 which provides space for gear assembly 18 during the steering movement. The tube extends downward from this bend by means of the inclining tube part 24 which further transposes by means of bend 16 into a substantially horizontal tube part 25 which, as stated, extends to a position close to the rear axle. At least the final part of tube part 25 comprises a round inner side for receiving rotatably therein a bush 22 of the rear wheel assembly.

The rear wheel assembly comprises this bush 22 which is mounted on rear axle 23. This rear axle comprises a part 36 which is horizontal in the position of use, in addition to a right-hand part 38 and a left-hand part 37 which each extend upward at an angle from horizontal part 36. By using the angle it becomes possible to also mount wheels 31,32 on the axle at an angle relative to the vertical, whereby a relatively wide wheelbase is obtained relative to the axle length. This wide wheelbase provides a greater stability, particularly in bends. A relatively narrow wheelbase can be obtained compared to known three-wheelers by making use of the tilting mechanism.

As stated, bush 22 is arranged rotatably in the end of frame tube 25. In order to hold the cycle upright under bias, torsion bar 20 is mounted at one end in the bush or on axle 36 and torsion bar 20 is mounted on the other side on the frame tube. The preferred embodiment for this fixing is shown. This preferred embodiment entails an opening being made in bend 16 of the frame. This opening is strengthened by means of strengthening sleeve 29. The torsion bar is inserted through this strengthening sleeve 29, which preferably has a cross-section which corresponds to the cross-section of the torsion bar, when bush 22 is placed in frame tube 25. The torsion bar is then locked by means of a locking bolt 21 with which bush 22 can also be held effectively in the bar. According to the present invention the hand-driven cycle can now tilt during use relative to the rear wheels thereof, whereby in bends the centre of gravity can move inward in similar manner as in two-wheelers.

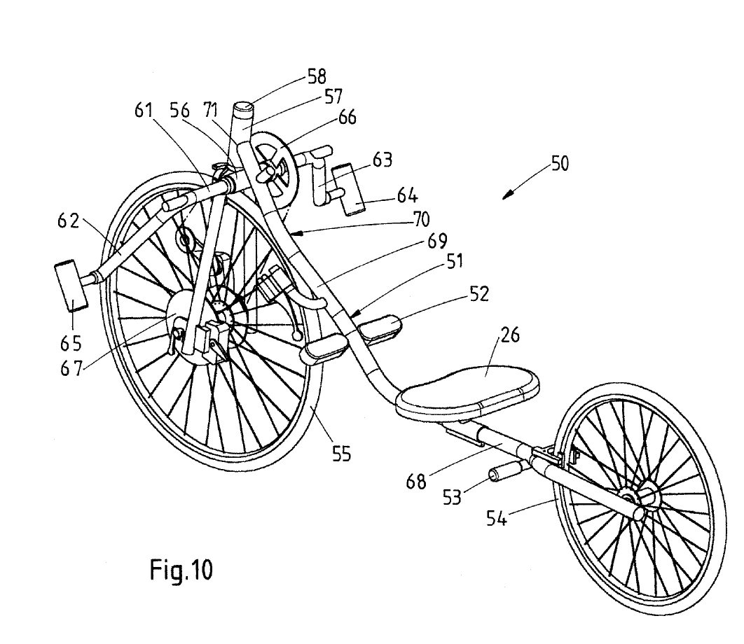

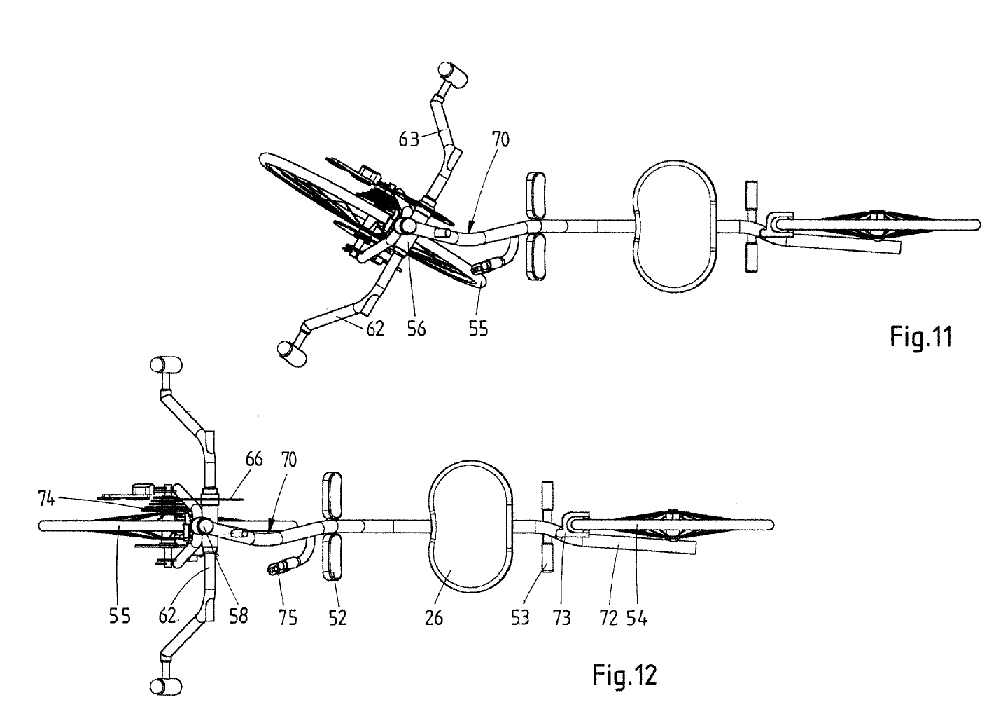

A further preferred embodiment according to the present invention (FIG. 10-12) relates to a two-wheeled hand-driven cycle 50. This cycle is based on a frame 51 from a tube which extends from the fork column 57 to the rear axle of rear wheel 54. The frame tube comprises several parts. The first part, which is fixed by means of a weld 71 to the fork column, is the steering bend 70. This steering bend allows for a steering movement of gear wheel 66. The steering bend is bent transversely of the direction of travel, which can be readily seen in the top view. Tube 69 extends downward from this steering bend 70 and transposes into the substantially horizontal tube part 68. The horizontal tube part 68 diverges close to the rear wheel in order to function as a one-armed rear fork on which the rear wheel is mounted. A rim brake 73 is also mounted hereon.

Saddle 26 and a footrest 53 are also fixed to the substantially horizontal tube part 68. A knee support or shin support is fixed to the inclining frame part 69. The legs of the rider extend forward from roughly the saddle to the knee which is bent such that the knee or the shin rests on support 52, after which the lower leg extends to the ankle support 53 on which the ankle, the shin or the foot can rest. The footrests of the three-wheeled embodiment can also be applied in this embodiment. A further advantage of such supports is that the feet can be used to stabilize the handlebar or steering movements.

Arranged on the front fork in similar manner as in the first embodiment is the drive shaft having mounted thereon a corresponding steering/drive member comprising a housing 56 for the drive shaft, the inclining parts 62,63 and handgrips 65,64, wherein the central rod parts 61 are arranged on the drive shaft which is arranged bearing-mounted in housing 56. An advantage of this embodiment is that the two-wheeler riding sensation can be fully realized with a front wheel drive hand-driven cycle. A disc brake 67 is also applied in this embodiment for braking front wheel 55. The brakes are operated by means of a brake lever arranged close to the handgrip (not shown).

In embodiments according to the invention it is possible to achieve a seat height between 35 and 75 centimeters, and preferably between 40 and 55 centimeters. Large wheels can also be applied, while an effective ATP output is also guaranteed. With a cycle according to the invention the rider can make optimum use of available muscle groups and an optimal trunk flexion. On a cycle according to the present invention the position of the pelvis is optimal for producing the ATP forces, since it is positioned relatively high in relation to the feet. The hamstrings are hereby relaxed, whereby the pelvis is not pulled backward.

Different components of the different embodiments can be interchanged according to the present invention to the extent this will be understood by the skilled person on the basis of this text.

In a tube which is further not shown it is possible to apply, instead of the bent tube, a tube which is substantially straight in side view and which extends from the fork column to the rear axle. In such an embodiment the seat position is slightly higher, whereby the ATP action can be enhanced still further.

The present invention is not limited to the described embodiments. The rights sought are defined by the following claims.

What is claimed as being new and desired to be protected by Letters Patent of the United States is as follows:

1. A hand-driven cycle on the front wheel, comprising:
a frame;
a rear wheel assembly arranged on a first side of the frame; and
a front wheel assembly which is arranged on a second side of the frame and which can be coupled pivotally to the frame by means of a fork column assembly, wherein the front wheel assembly having a fork for holding a wheel axle, a drive member to be driven by muscle power of a rider of the cycle, and a drive shaft for transmitting the muscle power to the front wheel by means of a transmission assembly, which drive shaft is arranged between the wheel axle and the fork column assembly.

2. The hand-drive cycle as set forth in claim 1, wherein the drive shaft is arranged on the front fork.

3. The hand-drive cycle as set forth in claim 1, wherein the frame comprises a tube extending rearward from the fork column assembly.

4. The hand-drive cycle as set forth in claim 1, wherein the drive member on either side of the drive shaft has a bent form leading to a handgrip on either side which is suitable for rotation about the drive shaft, wherein the handgrips are rotatable outside the legs of the rider.

5. The hand-drive cycle as set forth in claim 1, wherein the frame tube comprises a steering bend close to the fork column assembly for accommodating relevant components of the transmission assembly during a steering movement.

6. The hand-drive cycle as set forth in claim 5, wherein as seen from the side the steering bend makes a curve with a substantially vertical curvature.

7. The hand-drive cycle as set forth in claim 5, wherein as seen from the top side of the frame tube the bend makes a curve with a substantially horizontal curvature.

8. The hand-drive cycle as set forth in claim 1, wherein the rear wheel assembly comprises a rear wheel which is arranged substantially in line with a virtual centre line of the frame.

9. The hand-drive cycle as set forth in claim 8, wherein close to the rear wheel assembly the frame tube comprises a bend which is formed such that the rear wheel, in co-action with the rear wheel assembly, is substantially aligned with the centre line.

10. The hand-drive cycle as set forth in claim 8, comprising a first support for supporting a knee or an upper part of a shin which is arranged forwardly of a saddle on the frame tube, and a second support rearward and downward relative to the first support for supporting a foot, ankle or lower part of the shin.

11. The hand-drive cycle as set forth in claim 1, wherein the rear wheel assembly comprises a rear axle extending to two sides substantially perpendicularly of a virtual centre line of the frame for the purpose of holding two wheels on either side of the centre line.

12. The hand-drive cycle as set forth in claim 11, wherein the rear axle comprises on either side a sharp bend or a tube placed obliquely in the axle for arranging the wheels in a tilted position.

13. The hand-drive cycle as set forth in claim 11, comprising a biasing assembly for holding the rear wheel assembly under bias in a predetermined orientation relative to the frame.

14. The hand-drive cycle as set forth in claim 13, wherein the biasing assembly comprises a torsion member which close to one end is mounted on the rear wheel assembly and close to the other end is mounted on the frame, for the purpose of providing the bias, and a rotation member for rotating the rear wheel assembly relative to the frame, and the frame comprises a fixing location for fixing an end part of the torsion member.

15. The hand-drive cycle as set forth in claim 13, wherein the biasing assembly comprises a tube which can be placed rotatably in a round end part of the frame.

16. The hand-drive cycle as set forth in claim 1, wherein the front wheel assembly comprises a footrest on either side.
